(19) United States
(12) Patent Application Publication
(10) Pub. No.: US 2004/0050828 A1
(43) Pub. Date: Mar. 18, 2004

(54) Plasma arc torch vented shield system

(76) Inventors: Johnathon Brasseur, Cornish, NH (US); Kevin D. Horner-Richardson, Cornish, NH (US)

Correspondence Address: HARNESS, DICKEY, & PIERCE, P.L.C, 7700 BONHOMME, STE 400, ST. LOUIS, MO, 63105, US

(21) Appl. No.: 10/652,741

(22) Filed: Aug. 29, 2003

Related U.S. Application Data
(60) Provisional application No. 60/412,035, filed on Sep. 18, 2002.

(51) Int. Cl. B23K 9/00

(52) U.S. Cl. 219/121.48

(57) ABSTRACT

Vented shield systems for plasma arc torches are provided that comprise a shield cup body defining a distal end portion and at least one gas passage formed along the distal end portion. Additionally, a shield cap is disposed proximate the distal end portion with a flow control member disposed within the shield cap. Accordingly, a portion of a secondary gas is vented proximally through the gas passage and another portion of the secondary gas is vented distally through the flow control member. In another form, a shield cap is provided that comprises an annular ridge that blocks the secondary gas from flowing through the gas passage formed in the shield cup body. Further, methods of venting a secondary gas from a plasma arc torch are provided wherein a portion of the secondary gas is vented proximally and another portion of the secondary gas is vented distally.

### CROSS-REFERENCE TO RELATED APPLICATIONS

This application is based upon and claims priority of Provisional Patent Application, Serial No. 60/412,035, entitled “Plasma Arc Torch Vented Shield,” filed Sep. 18 2002, the contents of which are incorporated herein by reference in their entirety and continued preservation of which is requested.

### FIELD OF THE INVENTION

The present invention relates generally to plasma arc torches and more particularly to devices and methods for venting secondary gas from plasma arc torches.

### BACKGROUND OF THE INVENTION

Plasma arc torches, also known as electric arc torches, are commonly used for cutting, marking, gouging, and welding metal workpieces by directing a high energy plasma stream consisting of ionized gas particles toward the workpiece. In a typical plasma arc torch, the gas to be ionized is supplied to a distal end of the torch and flows past an electrode before exiting through an orifice in the tip, or nozzle, of the plasma arc torch. The electrode has a relatively negative potential and operates as a cathode. Conversely, the torch tip constitutes a relatively positive potential and operates as an anode. Further, the electrode is in a spaced relationship with the tip, thereby creating a gap, at the distal end of the torch. In operation, a pilot arc is created in the gap between the electrode and the tip, which heats and subsequently ionizes the gas. Further, the ionized gas is blown out of the torch and appears as a plasma stream that extends distally off the tip. As the distal end of the torch is moved to a position close to the workpiece, the arc jumps or transfers from the torch tip to the workpiece because the impedance of the workpiece to ground is lower than the impedance of the torch tip to ground. Accordingly, the workpiece serves as the anode, and the plasma arc torch is operated in a “transferred arc” mode.

In several plasma arc torches, a secondary gas is provided through the plasma arc torch that flows distally around the tip to stabilize the plasma stream exiting the central exit orifice. Additionally, shields are often secured to a plasma arc torch, proximate the tip portion, in order to prevent molten material from splattering against and damaging components of the plasma arc torch such as the tip or electrode, among others. Accordingly, the secondary gas that is used to stabilize the plasma stream is sometimes vented from the shields for proper operation of the plasma arc torch.

Further, existing shields that include passages for the venting of a secondary gas cannot be reused as a shield where venting is not desirable during operation of the plasma arc torch. As a result, an operator must use a plurality of shields with different plasma arc torches and applications.

### SUMMARY OF THE INVENTION

In one preferred form, the present invention provides a vented shield system that comprises a shield cup body defining a distal end portion and at least one gas passage extending along the distal end portion. Further, the vented shield system comprises a shield cap disposed proximate the distal end portion of the shield cup body and a flow control member disposed within the shield cap. In operation, a portion of a secondary gas flowing through the plasma arc torch is vented distally through the flow control member and another portion of the secondary gas is vented proximally through the gas passage. Preferably, the portion of secondary gas flowing through the flow control member defines a flow rate and the portion of secondary gas flowing through the gas passage defines another flow rate such that the flow rate of the secondary gas flowing through the flow control member is approximately the same as the flow rate of the secondary gas flowing through the gas passage.

In another form, a vented shield system is provided that comprises a shield cup body defining a distal end portion and at least one gas passage extending along the distal end portion. Further, the vented shield system comprises a shield cap disposed proximate the distal end portion of the shield cup body, wherein the shield cap defines an annular ridge. In operation, the annular ridge blocks a secondary gas from flowing through the gas passage of the shield cup body such that substantially all of the secondary gas flows distally along the exterior of a tip disposed within the plasma arc torch.

In yet another form, a method of venting a secondary gas from a plasma arc torch is provided that comprises the steps of directing a portion of the secondary gas distally through a flow control member in a vented shield system and directing another portion of the secondary gas proximally through at least one gas passage in the vented shield system.

Further, a method of venting a secondary gas from a plasma arc torch is provided that comprises the steps of directing a secondary gas distally through a vented shield system, blocking the secondary gas from flowing proximally through the vented shield system, and directing the secondary gas distally along an exterior portion of a tip disposed within the plasma arc torch.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side view of a vented shield system secured to an exemplary plasma arc torch in accordance with the principles of the present invention;

FIG. 2 is a perspective view of a vented shield system constructed accordance with the principles of the present invention;

FIG. 3 is a cross-sectional view of a vented shield system constructed in accordance with the principles of the present invention;

FIG. 4a is a bottom plan view of a shield cup body constructed in accordance with the teachings of the present invention;

FIG. 4b is a perspective view of the shield cup body in accordance with the teachings of the present invention;

FIG. 4c is a side view of the shield cup body in accordance with the teachings of the present invention;

FIG. 5 is a bottom plan view of a shield cap constructed in accordance with the principles of the present invention;

FIG. 6 is a perspective view of a second embodiment of a shield cap constructed in accordance with the principles of the present invention;

FIG. 7 is a cross-sectional view through a vented shield system with the second embodiment of a shield cap constructed in accordance with the principles of the present invention

FIG. 8 is a cross-sectional view through a vented shield system with a third embodiment of a shield cap constructed in accordance with the principles of the present invention; and

FIG. 9 is a cross-sectional view through a vented shield system with a fourth embodiment of a shield cap constructed in accordance with the principles of the present invention.

### DETAILED DESCRIPTION OF THE PREFERRED EMBODIMENTS

The following description of the preferred embodiments is merely exemplary in nature and is in no way intended to limit the invention, its application, or uses.

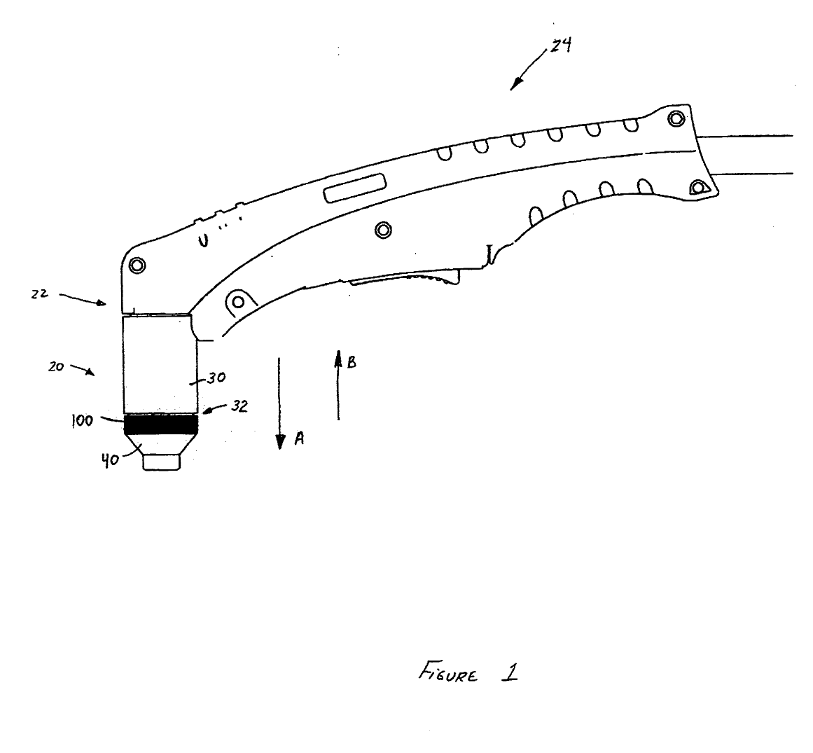

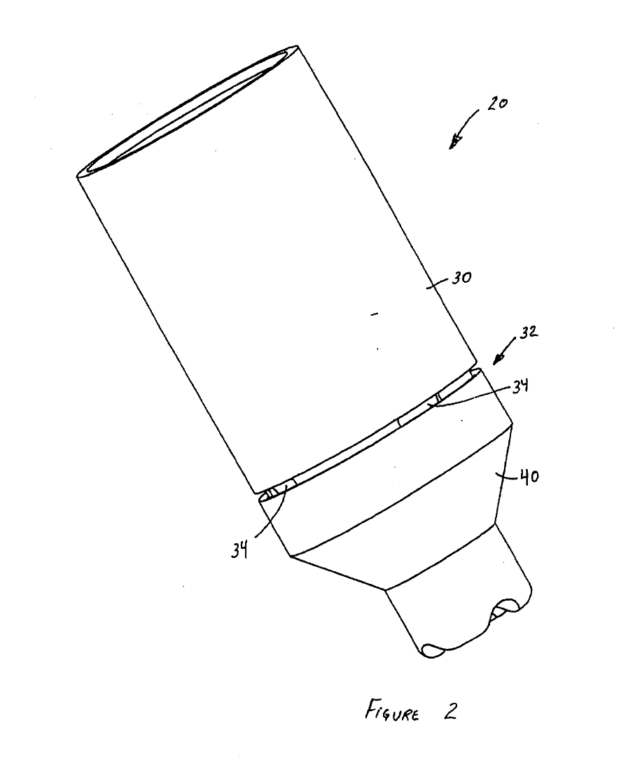

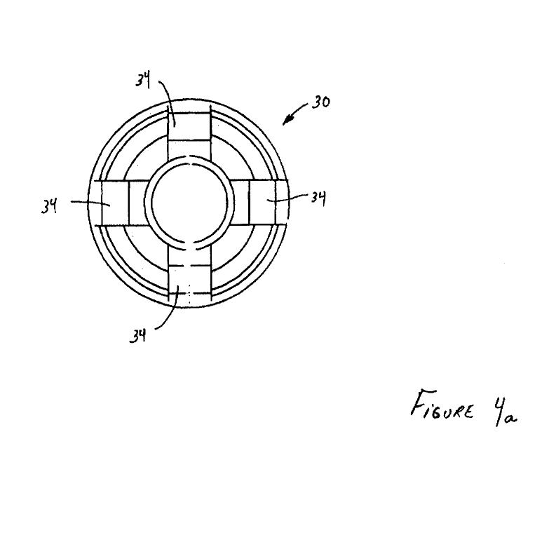

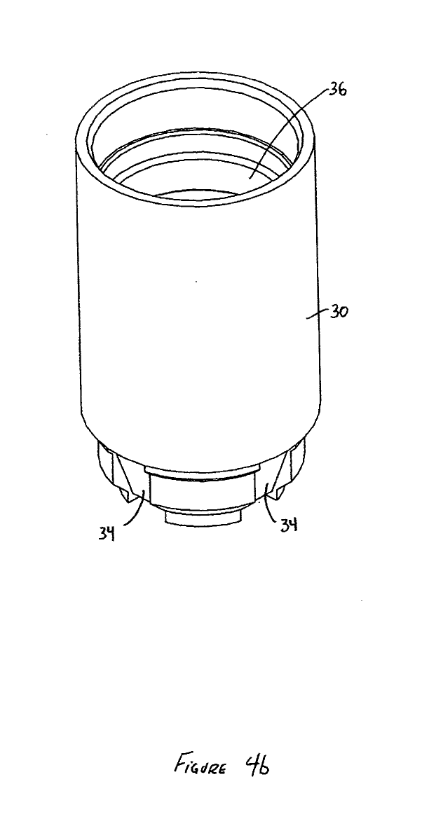

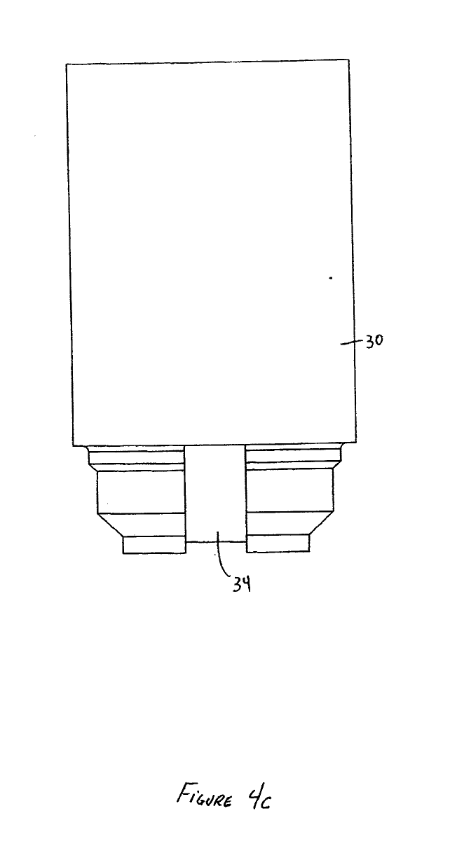

Referring to the drawings, a vented shield system for use in a plasma arc torch is illustrated and generally indicated by reference numeral 20 in FIGS. 1 through 4. The vented shield system 20 is disposed at a distal portion 22 of a plasma arc torch 24 and is used to block molten material from splattering against portions of the plasma arc torch 24 while venting portions of a secondary gas therefrom. As shown, the vented shield system 20 comprises a shield cup body 30 defining a distal end portion 32 and a plurality of gas passages 34 extending along the distal end portion 32. Preferably, four (4) gas passages 34 (which are best shown in FIG. 4) are employed in one form of the present invention and are spaced evenly around the periphery of the distal end portion 32. However, one or more gas passages 34, further with different spacing than those illustrated and described herein, may be employed while remaining within the scope of the present invention. As used herein, distal direction or distally is the direction towards the distal portion 22 as indicated by arrow A, and proximal direction or proximally is the direction towards arrow B.

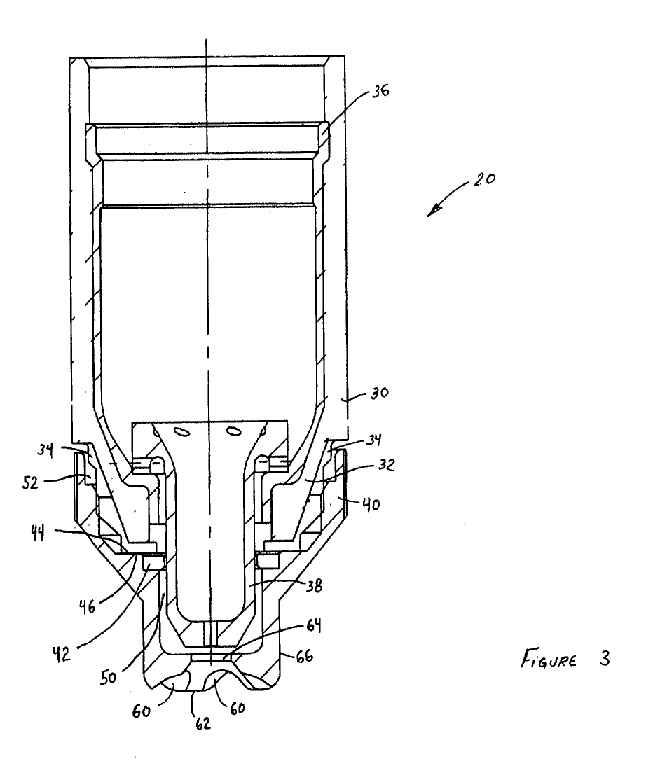

The vented shield system 20 further comprises a conductive insert 36, as best shown in FIG. 3, that is used to maintain electrical continuity through the positive, or anodic, potential side of the plasma arc torch 24. Accordingly, the shield cup body 30 is nonconductive. As shown, a tip 38 contacts the conductive insert 36 to maintain electrical continuity with other anodic components of the plasma arc torch 24, which components are not illustrated herein for purposes of clarity. Exemplary operation of a plasma arc torch is shown and described in U.S. Pat. No. 6,163,008, which is commonly assigned with the present application and the contents of which are incorporated herein by reference in their entirety.

The vented shield system 20 also comprises a shield cap 40 that is disposed proximate the distal end portion 32 of the shield cup body 30 and a flow control member 42 disposed within the shield cap 40. Preferably, the shield cap 40 is threadably engaged with the shield cup body 30, although other attachment methods commonly known in the art may also be employed. As further shown, a distal face 44 formed on the shield cup body 30 abuts a proximal face 46 formed in the shield cap 40. Additionally, the distal face 44 abuts the flow control member 42 such that flow of a secondary gas, which is described in greater detail below, is prevented from flowing through the interface between the shield cup body 30 and the shield cap 40 along the distal face 44 and the proximal face 46, respectively. Moreover, the flow control member 42 is a nonconductive member with sufficient dielectric to prevent arcing between the tip 38 and the shield cap 40 during operation of the plasma arc torch 24.

As shown in FIG. 3, a secondary gas passageway 50 is formed between the flow control member 42 and the tip 38, while another secondary gas passageway 52 is formed between the gas passages 34 in the shield cup body 30 and the shield cap 40. In operation, a portion of the secondary gas flow is directed distally through the secondary gas passageway 50, while another portion of the secondary gas is directed proximally through the secondary gas passageway 52. Accordingly, the flow of secondary gas for proper operation of the plasma arc torch 24 is controlled through the use of secondary gas passageways 50 and 52. Preferably, the flow rate of secondary gas through secondary gas passageway 50 is approximately the same as the flow rate of secondary gas through secondary gas passageway 52 such that the ratio of secondary gas flow to control the plasma stream to secondary gas flow that is vented is approximately 1:1. In one form of the present invention, the flow rate through both secondary gas passageways 50 and 52 is approximately 80 cfh (cubic feet per hour).

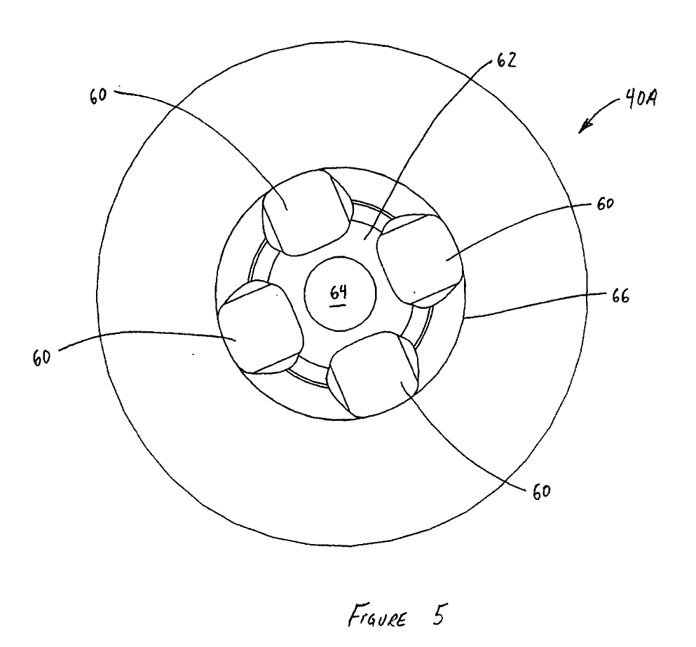

Referring now to FIG. 5 and also to FIG. 3, the shield cap 40 in one form, illustrated and shown as 40A, comprises a plurality of channels 60 formed on a distal face 62 and extending radially from an exit orifice 64 to an annular wall 66. The channels 60 provide a passage for the flow of gas during operation of the plasma arc torch 24 while also providing a passage for the flow of molten material that splatters during cutting operations. As shown, four (4) channels are employed in one form of the present invention and are spaced evenly around the distal face 62. However, one or more channels 60, further with different spacing than those illustrated and described herein, may be employed while remaining within the scope of the present invention. Further, the shield cap 40A is used for drag cutting applications in plasma arc torches, wherein the distal face 62 contacts a work piece (not shown) during cutting operations.

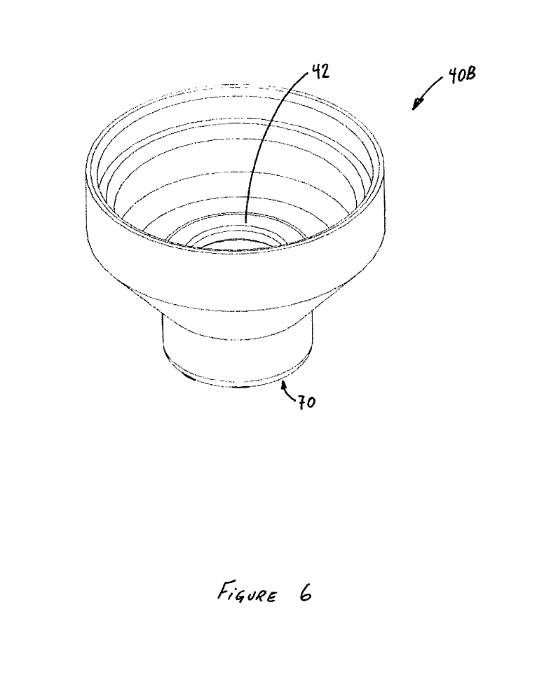

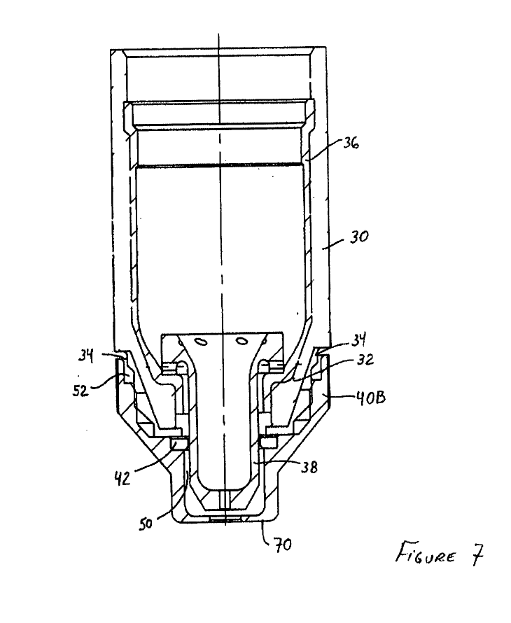

Referring now to FIGS. 6 and 7, yet another shield cap for use with the vented shield system 20 according to the present invention is illustrated and generally indicated by reference numeral 40B. The shield cap 40B directs the flow of secondary gas as previously described and comprises a distal face 70 to block molten material from contacting portions of the plasma arc torch. Additionally, the flow control member 42 is disposed within the shield cap 40B as shown. Further, the shield cap 40B is preferably used for automated, or mechanized, applications in plasma arc torches.

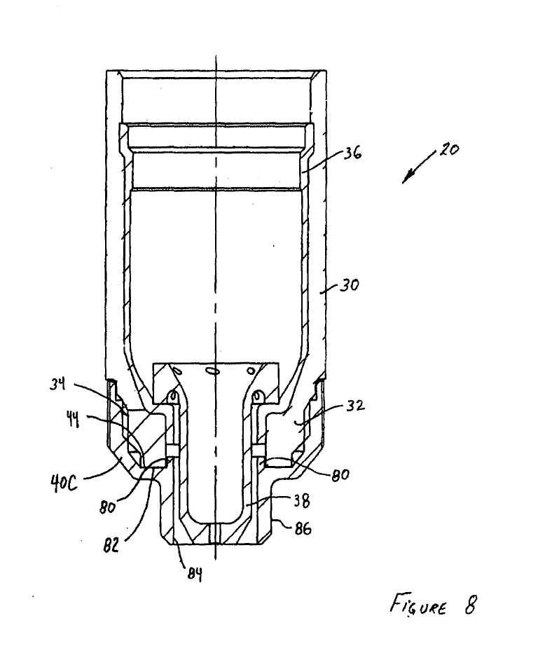

Another form of the present invention is illustrated in FIG. 8, wherein an alternate shield cap 40C is employed that defines an annular ridge 80 as shown. The shield cap 40C does not have a flow control member disposed therein as previously described. Rather, the annular ridge 80 nests inside the shield cup body 30 as shown, while the distal face 44 formed on the shield cup body 30 abuts a proximal face 82 formed within the shield cap 40C. Accordingly, the flow of secondary gas through the gas passages 34 is blocked and substantially all of the secondary gas flows between an interior wall 84 of the shield cap 40C and the tip 38. Therefore, substantially the same shield cup body 30 as previously described may be used whether or not secondary gas is vented through the vented shield system 20. Preferably, an annular wall 86 extends distally to cover and protect a portion of the tip 38 from molten material during operation of the plasma arc torch 24. Further, the shield cap 40C as shown is used for gouging applications in plasma arc torches.

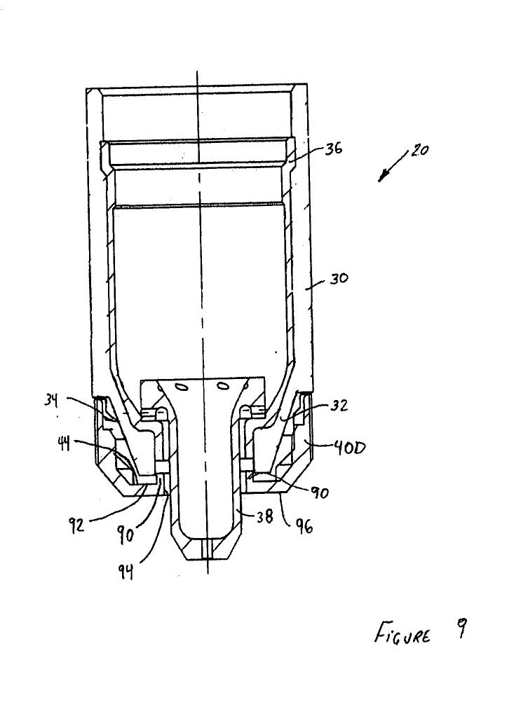

Yet another form of the present invention is illustrated in FIG. 9, wherein an alternate shield cap 40D is employed that similarly defines an annular ridge 90 as shown. The shield cap 40D does not have a flow control member disposed therein as previously described. Rather, the annular ridge 90 nests inside the shield cup body 30 as shown, while the distal face 44 formed on the shield cup body 30 abuts a proximal face 92 formed within the shield cap 40D. Accordingly, the flow of secondary gas through the gas passages 34 is blocked and all of the secondary gas flows between an interior wall 94 of the shield cap 40D and the tip 38. Therefore, substantially the same shield cup body 30 as previously described may be used whether or not secondary gas is vented through the vented shield system 20. As shown, the shield cap 40D defines a distal face 96 that covers and protects the shield cup body 30 and other torch components from molten material during operation of the plasma arc torch 24, while the tip 38 extends distally beyond the distal face 96. Accordingly, the shield cap 40D as shown is used for deflecting molten material away from the shield cup body 30 along with other torch components.

As shown throughout, the shield caps (40A through 40D) preferably employ a knurled surface 100 as shown in FIG. 1 to provide an improved gripping surface for attachment of the shield caps to the shield cup body 30. However, the shield caps may employ a smooth surface or a different texture surface while remaining within the scope of the present invention.

As used herein, a plasma arc torch, whether operated manually or automated, should be construed by those skilled in the art to be an apparatus that generates or uses plasma for cutting, welding, spraying, gouging, or marking operations, among others. Accordingly, the specific reference to plasma arc cutting torches, plasma arc torches, or manually operated plasma arc torches herein should not be construed as limiting the scope of the present invention. Furthermore, the specific reference to providing gas to a plasma arc torch should not be construed as limiting the scope of the present invention, such that other fluids, e.g. liquids, may also be provided to the plasma arc torch in accordance with the teachings of the present invention.

The description of the invention is merely exemplary in nature and, thus, variations that do not depart from the substance of the invention are intended to be within the scope of the invention. Such variations are not to be regarded as a departure from the spirit and scope of the invention.

What is claimed is:

1. A vented shield system for use in a plasma arc torch comprising:
a shield cup body defining a distal end portion and at least one gas passage extending along the distal end portion;
a shield cap disposed proximate the distal end portion of the shield cup body; and
a flow control member disposed within the shield cap,
wherein a portion of a secondary gas flowing through the plasma arc torch is vented distally through the flow control member and another portion of the secondary gas is vented proximally through the gas passage.

2. The vented shield system according to claim 1 wherein the portion of secondary gas flowing through the flow control member defines a flow rate and the portion of secondary gas flowing through the gas passage defines another flow rate such that the flow rate of the secondary gas flowing through the flow control member is approximately the same as the flow rate of the secondary gas flowing through the gas passage.

3. The vented shield system according to claim 1, wherein the shield cap defines a distal face and a plurality of channels formed in the distal face, the channels providing gas flow passages and molten material passages.

4. The vented shield system according to claim 1, wherein the shield cap defines a distal face to block molten material from contacting portions of the plasma arc torch.

5. The vented shield system according to claim 1 further comprising four gas passages extending along the distal end portion of the shield cup body.

6. The vented shield system according to claim 1 further comprising a conductive insert disposed within the shield cup body, wherein a tip of the plasma arc torch contacts the conductive insert for electrical continuity within the anodic potential side of the plasma arc torch.

7. The vented shield system according to claim 6, wherein the flow control member is nonconductive and provides a proper dielectric to prevent arcing between the tip and the shield cap.

8. A vented shield system for use in a plasma arc torch comprising:
a shield cup body defining a distal end portion and at least one gas passage extending along the distal end portion;
a shield cap disposed proximate the distal end portion of the shield cup body, the shield cap defining an annular ridge,
wherein the annular ridge blocks a secondary gas from flowing proximally through the gas passage of the shield cup body.

9. The vented shield system according to claim 8, wherein the shield cap further defines an extended distal wall that blocks molten material from contacting portions of the plasma arc torch.

10. The vented shield system according to claim 8, wherein the shield cap further defines a distal face to block molten material from contacting portions of the plasma arc torch.

11. The vented shield system according to claim 8 further comprising four gas passages extending along the distal end portion of the shield cup body.

12. The vented shield system according to claim 8 further comprising a conductive insert disposed within the shield cup body, wherein a tip of the plasma arc torch contacts the conductive insert for electrical continuity within the anodic potential side of the plasma arc torch.

13. A shield cup body for use in venting a secondary gas from a plasma arc torch, the shield cup body defining a distal end portion and at least one gas passage extending along the distal end portion, wherein a portion of a secondary gas flowing through the plasma arc torch is vented proximally through the gas passage.

14. An apparatus for use in venting a secondary gas from a plasma arc torch, the apparatus comprising:
a shield cap disposed proximate a distal end portion of the plasma arc torch; and
a flow control member disposed within the shield cap,
wherein a portion of a secondary gas flowing through the plasma arc torch is vented distally through the flow control member.

15. The apparatus according to claim 15, wherein the flow control member is nonconductive and provides a proper dielectric to prevent arcing within the plasma arc torch.

16. A method of venting a secondary gas from a plasma arc torch, the method comprising the steps of:
(a) directing a portion of the secondary gas distally through a flow control member in a vented shield system; and
(b) directing another portion of the secondary gas proximally through at least one gas passage in the vented shield system.

17. The method according to claim 16 further comprising the steps of:
(a) controlling a flow rate of the secondary gas through the flow control member; and
(b) controlling a flow rate of the secondary gas through the gas passage,
wherein the flow rate of the secondary gas flowing through the flow control member is approximately the same as the flow rate of the secondary gas flowing through the gas passage.

18. A method of venting a secondary gas from a plasma arc torch, the method comprising the steps of:
(a) directing a secondary gas distally through a vented shield system;
(b) blocking the secondary gas from flowing proximally through the vented shield system; and
(c) directing the secondary gas distally along an exterior portion of a tip disposed within the plasma arc torch.
